(19) United States
(12) Patent Application Publication
(10) Pub. No.: US 2008/0182480 A1
(43) Pub. Date: Jul. 31, 2008

(54) AIR VALVE CONNECTOR

(75) Inventor: Kevin G. Donahue, Harvard, MA (US)

Correspondence Address: R.D. JOHNSON & ASSOCIATES, P.C., 20 PICKERING STREET, P.O.BOX 920353, NEEDHAM, MA, 02492, US

(73) Assignee: AIRBRIX LLC, Harvard, MA (US)

(21) Appl. No.: 11/875,485

(22) Filed: Oct. 19, 2007

Related U.S. Application Data
(60) Provisional application No. 60/862,151, filed on Oct. 19, 2006.

(51) Int. Cl. A63H 3/06; F16K 51/00; A63H 33/04

(52) U.S. Cl. 446/89; 251/356; 446/224; 29/890.12; 29/592

(57) ABSTRACT

An inexpensive air valve-connector can enable the construction of inflatable structures having multiple inflatable components. In particular, an inflatable component can be connected to an inflated structure and inflate without deflating the structure. Specifically, positive air pressure generated by an air blower, i.e. a fan, is used to inflate a structure composed of one or more blocks that self-inflate upon connection to inflated blocks. The air valve-connector can be embodied in a low-cost building block toy. The air valve-connector can also be used to create other inflatable structures, such as decorations and signage.

The air valve-connector comprises two light-weight connectors that can exist on opposite sides of the same block. The valve includes a compressible material, such as foam, that is actuated to open the valve. When two blocks are connected via the air valve, air is transferred from a first block to a second block.

### RELATED APPLICATION

This application claims the benefit of U.S. Provisional Application No. 60/862,151, filed on Oct. 19, 2006 (Attorney Docket Number 4008.3003US01). The entire teachings of the above application are incorporated herein by reference.

### BACKGROUND

Building block toys have been popular for decades. The first block toys consisted of stackable solid blocks composed of wood or other materials. Plastic injection molding technology then enabled a variety of connectable plastic blocks, such as LEGO bricks. In general, plastic blocks rely on the precise fit of male and female connectors to produce structure. Other popular construction toys include magnetic and metal elements that use magnetic force to create a structure.

Currently, inflatable blocks do exist that require traditional inflation via the use of human lungs or a pump. Like beach balls, these blocks inflate and then exist as standalone structures that can be connected to each other via hook-and-loop fasteners, adhesion, geometric fittings, or other means.

Other inflatable structures include theme and holiday characters. Such structures are inflated by an air blower, which continuously runs to maintain positive air pressure within the structure.

### SUMMARY

In accordance with particular embodiments of the invention, an inexpensive air valve-connector can enable the construction of inflatable structures having multiple inflatable components. In particular, an inflatable component can be connected to an inflated structure and inflate without deflating the structure. The air valve-connector can be embodied in a low-cost building block toy. The air valve-connector can also be used to create other inflatable structures, such as decorations and signage.

More particularly, an air valve-connector can allow air to flow between the two inflatable components, when subjected to a continuous flow of air. Specifically, positive air pressure generated by an air blower, i.e. a fan, is used to inflate a structure composed of one or more blocks that self-inflate upon connection to inflated blocks.

One component of the toy building block is the air valve-connector, which comprises two light-weight connectors that can exist on opposite sides of the same block. The valve includes a compressible material, such as foam, that is actuated to open the valve. When two blocks are connected via the air valve, air is transferred from a first block to a second block. Particular embodiments feature the ability to create large lightweight low-cost structures that are fun to assemble and require minimal storage space.

In accordance with one embodiment, a gas flow valve can include a housing and a block of porous material.

The housing can include a first gas port and a second gas port. The housing defines a cavity such that air flows between the first gas port and the second gas port through a flow path within the cavity.

The block of porous material can be disposed within the cavity, such that the flow path extends through the porous material. Furthermore, the porous material can be compressible, wherein the flow path extends through the porous material when the porous material is uncompressed and does not extend through the porous material when the porous material is compressed.

In accordance with another embodiment, an inflatable structure can include an inflatable body and a plurality of valve connectors secured to the inflatable body. Each valve connector can include a housing and a block of compressible material.

The housing can include a first gas port and a second gas port. The housing defines a cavity such that air flows between the first gas port and the second gas port through a flow path within the cavity.

The block of compressible material can be disposed within the cavity to control the flow of gas through the flow path. Furthermore, the compressible material can be porous, wherein the flow path extends through the compressible material when the compressible material is uncompressed and does not extend through the compressible material when the compressible material is compressed.

More particularly, the inflatable body can be fabricated form any desired shape, such as a toy block or an animated structure. Furthermore, the inflatable body is made from a porous or non-porous material.

The valve connectors can include a male connector and a female connector. When assembled, a first valve connector can receive a continuous flow of air from a flow source.

In accordance with another embodiment, a system for assembling an inflatable structure can include a plurality of inflatable components and a blower module.

Each inflatable components can include an inflatable body and a plurality of valve connectors secured to the inflatable body. Each valve connector can include a housing and a block of compressible material.

The housing can include a first gas port and a second gas port. The housing defines a cavity such that air flows between the first gas port and the second gas port through a flow path within the cavity.

The block of compressible material can be disposed within the cavity to control the flow of gas through the flow path. Furthermore, the compressible material can be porous, wherein the flow path extends through the compressible material when the compressible material is uncompressed and does not extend through the compressible material when the compressible material is compressed.

The blower module can provide a continuous flow of air through a source gas port, which is connectable to a first gas port of a component.

In particular, each inflatable component can form a toy block or part of an animated structure. The toy blocks can be of various dimensions. Furthermore, the inflatable body can be made from a porous or non-porous material.

The valve connectors can include a male connector and a female connector.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a female connector for an unconnected air valve-connector.

FIG. 2 is a plan cross-sectional view of the female connector of FIG. 1.

FIG. 3 is a perspective view of a male connector for an air valve-connector.

FIG. 4 is a plan cross-sectional view of the male connector of FIG. 3.

FIG. 5 is a perspective view of the air valve-connector in the connected state.

FIG. 6 is a plan cross-sectional view of the air valve-connector in the connected state.

FIG. 7 is a perspective view of an exemplary inflatable toy block employing the air valve-connector of FIGS. 1-6.

FIG. 8 is a perspective view of another exemplary inflatable toy block employing the air valve-connector of FIGS. 1-6.

FIG. 9 is a perspective view of a plurality of interconnected, self-inflating toy blocks.

### DETAILED DESCRIPTION

In accordance with a particular embodiment, a gas flow valve includes a housing and a moveable block of porous material. The housing defines a cavity such that air flows between a first gas port and a second gas port, through a flow path within the cavity. The block of porous material is disposed within the cavity such that the flow path extends through the block. Further details of particular female and male valve connectors are described below.

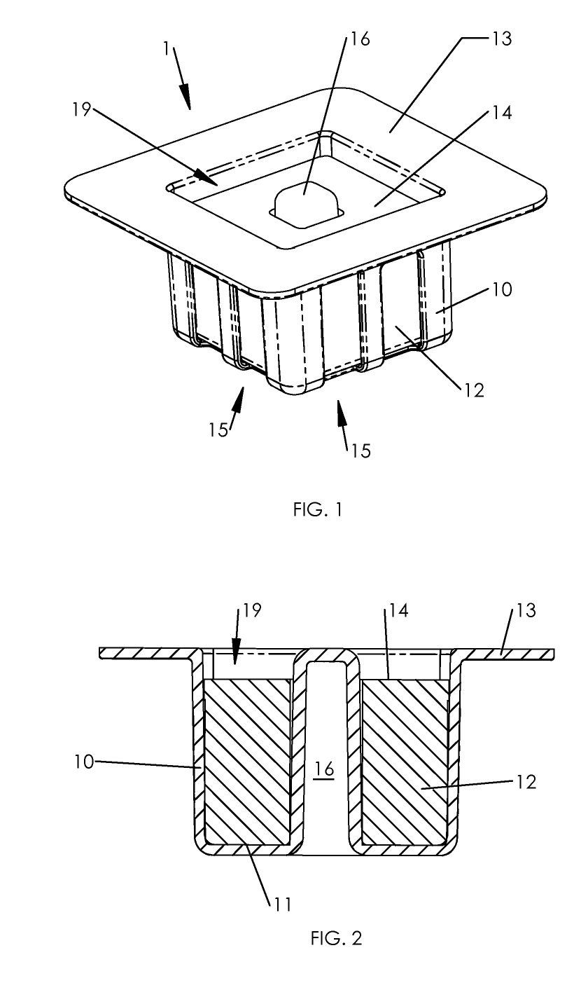

FIG. 1 is a perspective view of a female connector for an unconnected air valve-connector. The female connector 1 includes a female housing 10 that can be injection molded or stamped from plastic or metal. The female housing 10 includes an open top connection port 19 bordered by a flange 13 for adhering the female housing to an inflatable device body, and a plurality of inflation ports 15. As shown, the inflation ports 15 are shaped like window openings, but other openings or perforations can be used. Air flows into and out of the female connector 1 through the connection port 19 and the inflation port 15.

In this view a foam block 12 can be seen through the window openings 15. The foam block 12 includes a center bore to fit over a compression column 16.

Also shown is a protective covering 14, such as felt, for the foam block 12. The protective coating can be a layer of low friction material, such as felt, a plastic cap, a polyester sticker, or the foam can be covered with an air tight elastomer.

When the valve is unconnected, the foam block 12 inhibits, but does not necessarily prevent, air flow through the female connector 1. While the foam block 12 obstructs the window openings 15, the foam block 12 is porous so that air can escape from inside the inflatable device. This is important when the inflatable device is subjected to a continuous air flow, because if sufficient air cannot escape, the inflatable device can rupture. In a particular embodiment, the foam block 12 is fabricated from expanded low density polyethylene or polypropylene.

FIG. 2 is a plan cross-sectional view of the female connector of FIG. 1. As shown, the central compression column 16 is integrally formed with the housing 10 and extends from a base portion 11 of the housing 10. The foam block 12 can be adhered to the housing base 11. The female housing 10 can also include internal flanges (not shown) to hold the foam block 12 in the internal cavity and in a compressed state.

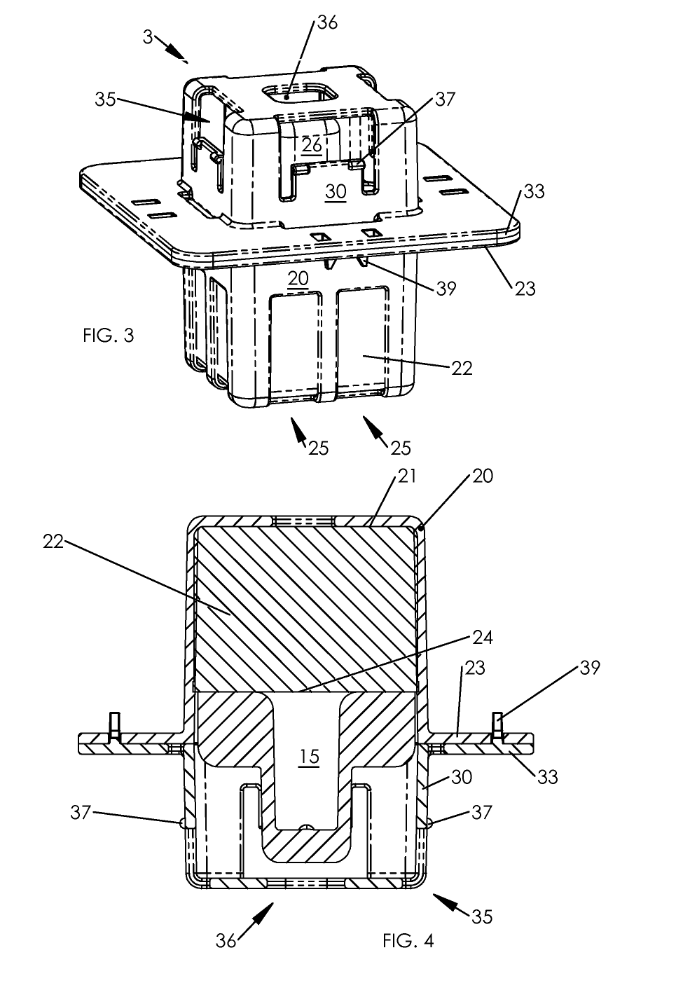

FIG. 3 is a perspective view of a male connector for an air valve-connector. The male connector 3 includes an internal housing 20 and an external housing 30 that can be injection molded or stamped from plastic or metal. The internal housing 20 includes a plurality of inflation ports 25 and the external housing 30 includes a plurality of connection ports 35. Air flows into and out of the male connector 3 through the ports 25, 35. The ports can be window-shaped openings as shown or use other perforations. In this view, a foam block 22 can be seen through the internal window openings 25 and a plunger 26 can be seen through the external window openings 35.

The internal housing 20 includes a flange 23 and the external housing 30 includes a flange 33. The flanges are fastened together by a fastener, such as glue, with or without the illustrated clips 39. Also shown are a plurality of pressure lips 37 that removably fasten the male housing 30 to the female housing 10 (FIGS. 1-2).

Like with the female connector 1 (FIGS. 1-2), when the valve is unconnected, the foam block 22 is porous and fabricated from expanded low density polyethylene or polypropylene, and inhibits air flow through the male connector 3. As such, air at a positive air pressure can escape from within an inflated block through the valve connector 3.

FIG. 4 is a plan cross-sectional view of the male connector of FIG. 3. In the male connector 3, note that the plunger 26 is unconnected to the internal housing 20 and therefore can be freely moved against the foam 22. The foam block 22 can be glued to the base 21 of the internal housing 20. The internal housing 20 can also includes internal flanges (not shown) to hold the foam block 22 in the internal cavity and in a compressed state.

Also shown is a protective covering 24, such as felt, for the foam block 22. Also note that the external housing 30 includes a central orifice 36, which is dimensioned to receive the compression column 16 from the female housing 10 (FIGS. 1-2).

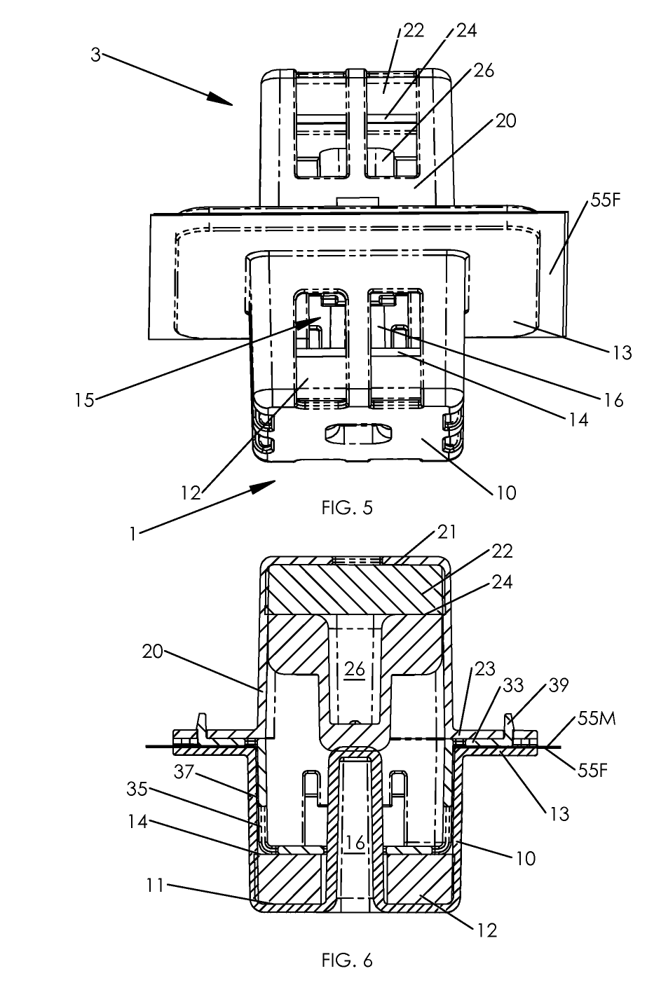

FIG. 5 is a perspective view of the air valve-connector in the connected state. In this view, the flange 13 of the female connector 1 is adhered to an inflatable body 55F.

To connect the valves, the male connector 3 and the female connector 1 are aligned, with the central orifice 36 of the external housing 30 aligned with the compression column 16 of the female housing 10. The external male housing 30 is then inserted into the female housing 10. The compression lips 37 engage with the female housing 10 at the window openings 15 to removably fasten the male housing 3 to the female housing 1.

FIG. 6 is a plan cross-sectional view of the air valve-connector in the connected state. As shown, a second inflatable device body 55M is adhered to the exposed surface of the external housing flange 33.

The external male housing 30 further compressed the female foam block 12 so that the male external window opening 35 interface with the female window openings 15. At the same time, the compression column 16 blocks the plunger 26 and forces the plunger 26 to further compress the male foam block 22, thus opening the internal male window openings 25. Air can now flow through the window opening ports 15, 25, 35.

While the foam valve has been shown having housings that are open cube shaped, with square profiles, the housing can be of any other suitable shape. In particular, the housings can be open cylinder shaped, with circular profiles. Furthermore, in other applications it may not be desirous for the foam blocks to be porous. In that case, porous foam blocks can be coated with an air tight material, such as rubber, urethane, or silicone.

In a particular embodiment of the invention, a block unit comprises a body of a lightweight fabric or plastic with connectors that feature the proper structure and elasticity to execute the required connection. When deflated, the blocks require very little space for storage. When connected to an air flow, the blocks self inflate.

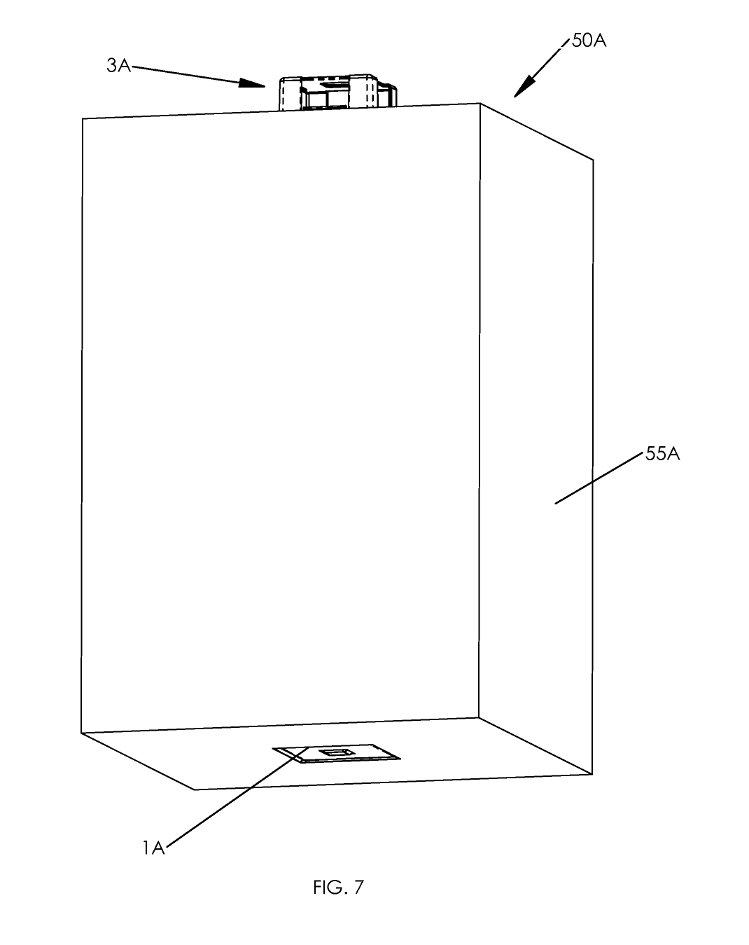

FIG. 7 is a perspective view of an exemplary inflatable toy block employing the air valve-connector of FIGS. 1-6. As shown, the toy block 50A is brick shaped with a body 55A defined by a lightweight porous material, such as ripstop nylon fabric, polyester, treated cotton, or balloon foil. In another embodiment, the material can be non-porous, such as Mylar, acetate, LDPE, or rubber. As shown, the block 50A includes one male connector 3A and one female connector 1A on opposite sides. The single-size block can be made in various dimensions, such as 12 inches high by 8 inches wide by 8 inches deep.

In a particular embodiment, the body 55A is fabricated from a LDPE film and the connector housings are fabricated from HDPE. The film is cut to size and folded to the desired shape. Once folded, the free edges are heat fused and excess material removed by heat snips. Those with ordinary skill in the art will recognize various other techniques for forming the desired shapes. The HDPE connector housings are then heat sealed to the LDPE body.

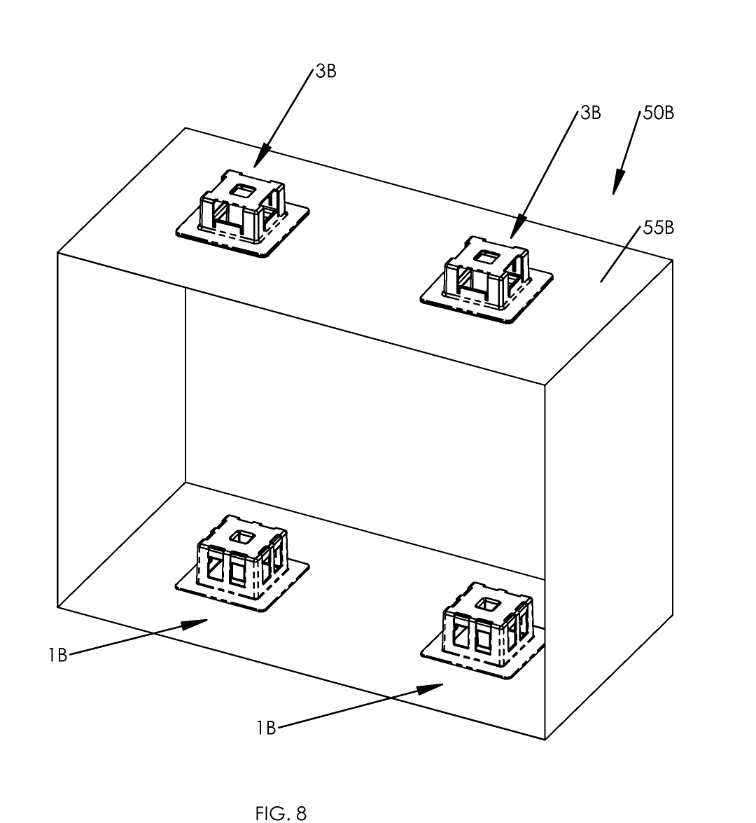

FIG. 8 is a perspective view of another exemplary inflatable toy block employing the air valve-connector of FIGS. 1-6. As shown, the toy block 50B is brick shaped with a body 55B. Unlike the block 50A of FIG. 7, the block 50B includes two male connectors 3B and two female connectors 1B on opposite sides. As such, the double block 50B would be twice as wide (e.g., 16 inches) as the single block of FIG. 7.

Other blocks can have more connectors per side, such as triple size blocks (e.g., 24 inches). In each case, the blocks are expected to be assembled into vertical structures with the female connectors down and the male connectors up.

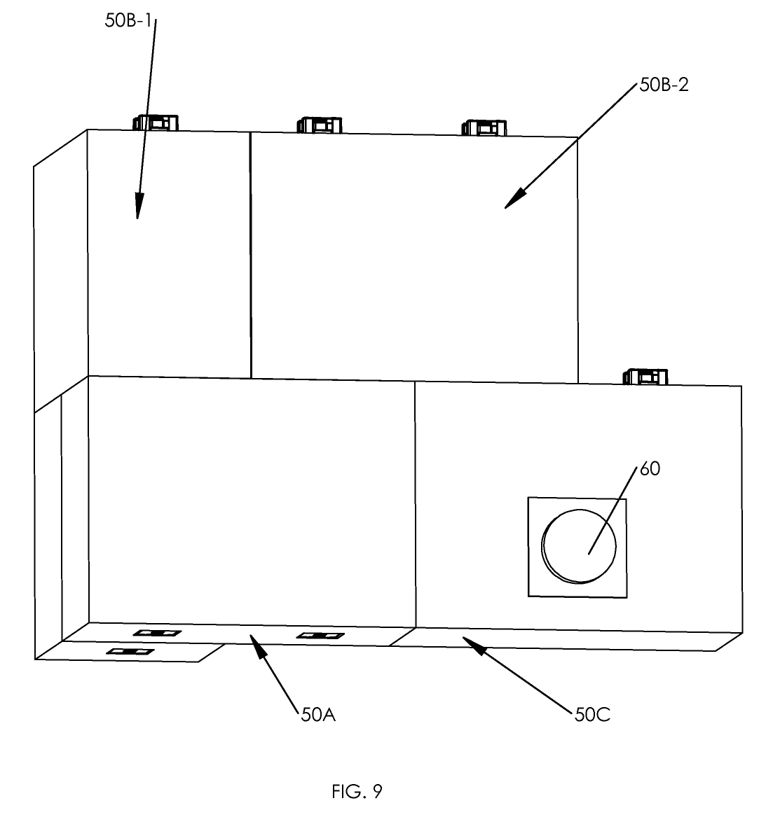

FIG. 9 is a perspective view of a plurality of interconnected, self-inflating toy blocks. The blocks can be assembled in various ways to make various structures. Blocks can be fabricated in various colors or have printed surfaces to encourage the use of patterns to create images and shapes. In addition to the simple blocks of FIGS. 7 and 8, a blower unit 60 can be enclosed within a block 50C. Such a blower block 50C is expected to be placed directly on the ground and thus would not require a bottom female connector; instead there would be at least one male connector at the top (two as shown).

Because the block structures are exposed to a continuous air flow, the blocks can wiggle or move to create an animated structure. Furthermore, the blocks can include additional features to create an audio sound, such as a whistle or musical tone, as the air is vented from the blocks.

While this invention has been particularly shown and described with references to particular embodiments, it will be understood by those skilled in the art that various changes in form and details may be made to the embodiments without departing from the scope of the invention encompassed by the appended claims. For example, various features of the embodiments described and shown can be omitted or combined with each other.

What is claimed is:

1. A gas flow valve, comprising:
a housing having a first gas port and a second gas port, the housing defining a cavity such that air flows between the first gas port and the second gas port through a flow path within the cavity; and
a block of porous material disposed within the cavity, the flow path extending through the porous material.

2. The valve of claim 1 wherein the porous material is compressible, wherein the flow path extends through the porous material when the porous material is uncompressed and does not extend through the porous material when the porous material is compressed.

3. An inflatable structure comprising:
an inflatable body;
a plurality of valve connectors secured to the inflatable body, each valve connector including:
a housing having a first gas port within the inflatable body and a second gas port outside the inflatable body, the housing defining a cavity such that air flows between the first gas port and the second gas port through a flow path within the cavity; and
a block of compressible material disposed within the cavity to control the flow of gas through the flow path.

4. The structure of claim 3 wherein the inflatable body forms a toy block.

5. The structure of claim 3 wherein the inflatable body forms an animated structure.

6. The structure of claim 3 wherein the inflatable body is made from a non-porous material.

7. The structure of claim 3 wherein the valve connectors include a male connector and a female connector.

8. The structure of claim 3 wherein the compressible material is porous, wherein the flow path extends through the compressible material when the compressible material is uncompressed and does not extend through the compressible material when the compressible material is compressed.

9. The structure of claim 3 wherein a first valve connector receives a continuous flow of air from a flow source.

10. A system for assembling an inflatable structure comprising:
a plurality of inflatable components, each component including:
an inflatable body;
a plurality of valve connectors secured to the inflatable body, each valve connector including:
a housing having a first gas port within the inflatable body and a second gas port outside the inflatable body, the housing defining a cavity such that air flows between the first gas port and the second gas port through a flow path within the cavity;
a block of compressible material disposed within the cavity to control the flow of gas through the flow path; and
a blower module for providing a continuous flow of air through a source gas port, the source gas port connectable to a first gas port of a component.

11. The system of claim 10 wherein each inflatable component form a toy block.

12. The system of claim 11 wherein the toy blocks are of various dimensions.

13. The system of claim 10 wherein the inflatable components form an animated structure.

14. The system of claim 10 wherein the inflatable body is made from a non-porous material.

15. The system of claim 10 wherein the valve connectors include a male connector and a female connector.

16. The system of claim 10 wherein the compressible material is porous, wherein the flow path extends through the compressible material when the compressible material is uncompressed and does not extend through the compressible material when the compressible material is compressed.

17. A method of manufacturing a gas flow valve, comprising:
fabricating a housing having a first gas port and a second gas port, the housing defining a cavity such that air flows between the first gas port and the second gas port through a flow path within the cavity; and
disposing a block of porous material within the cavity, wherein the flow path extends through the porous material.

18. The method of claim 17 wherein the porous material is compressible, wherein the flow path extends through the porous material when the porous material is uncompressed and does not extend through the porous material when the porous material is compressed.

19. A method of manufacturing an inflatable structure comprising:
fabricating an inflatable body;
securing a plurality of valve connectors to the inflatable body, each valve connector including:
a housing having a first gas port within the inflatable body and a second gas port outside the inflatable body, the housing defining a cavity such that air flows between the first gas port and the second gas port through a flow path within the cavity; and
a block of compressible material disposed within the cavity to control the flow of gas through the flow path.

20. The method of claim 19 wherein fabricating the inflatable body comprising shaping the inflatable body to form a toy block.

21. The method of claim 19 wherein fabricating the inflatable body comprising shaping the inflatable body to form an animated structure.

22. The method of claim 19 wherein the inflatable body is made from a non-porous material.

23. The method of claim 19 wherein the valve connectors include a male connector and a female connector.

24. The method of claim 19 wherein the compressible material is porous, wherein the flow path extends through the compressible material when the compressible material is uncompressed and does not extend through the compressible material when the compressible material is compressed.

25. The method of claim 19 wherein a first valve connector is dimensioned to receive a continuous flow of air from a flow source.
